(19) United States
(12) Patent Application Publication
(10) Pub. No.: US 2024/0232617 A1
(43) Pub. Date: Jul. 11, 2024

(54) DUAL ADAPTIVE TRAINING METHOD OF PHOTONIC NEURAL NETWORKS AND ASSOCIATED COMPONENTS

(71) Applicant: TSINGHUA UNIVERSITY, Beijing (CN)

(72) Inventors: Xing Lin, Beijing (CN); Zhengyang DUAN, Beijing (CN); Haiou ZHANG, Beijing (CN); Hang CHEN, Beijing (CN); Ziyang ZHENG, Beijing (CN); Hongkai XIONG, Beijing (CN)

(21) Appl. No.: 18/394,052

(22) Filed: Dec. 22, 2023

Related U.S. Application Data
(63) Continuation of application No. PCT/CN2023/115741, filed on Aug. 30, 2023.

(30) Foreign Application Priority Data
Jan. 10, 2023 (CN) 2023100359136

(51) Int. Cl. G06N 3/08; G06N 3/067

(52) U.S. Cl. CPC G06N 3/08; G06N 3/067

(57) ABSTRACT

A dual adaptive training method of photonic neural networks (PNN), includes constructing, in a computer, a PNN numerical model including a PNN physical model and a systematic error prediction network model, where the PNN physical model is an error-free ideal PNN physical model of a PNN physical system, the systematic error prediction network model is an error model of the PNN physical system; determining measurement values of the PNN physical system and measurement values of the PNN numerical model, where the measurement values of the PNN physical system include final output values of the PNN physical system, and the measurement values of the PNN numerical model include final output values of the PNN numerical model; determining a similarity loss function based on comparison results between the measurement values of the PNN physical system and the measurement values of the PNN numerical model; determining a task loss function based on fused results of the measurement values of the PNN physical system and the measurement values of the PNN numerical model; and optimizing and updating parameters of the PNN numerical model based on the similarity loss function and the task loss function for in situ training of the PNN physical model.

### CROSS-REFERENCE TO RELATED APPLICATION

This application is a continuation of PCT International Application No. PCT/CN2023/115741, filed on Aug. 30, 2023, which claims priority to Chinese Application No. 2023100359136 filed on Jan. 10, 2023, entitled “Dual Adaptive Training Method of Photonic Neural Networks and Associated Components”, which are hereby incorporated by reference in their entireties.

### TECHNICAL FIELD

The present application relates to the field of artificial intelligence, and in particular to a dual adaptive training method of photonic neural networks and associated components.

### BACKGROUND

Artificial intelligence (AI) is a new technology science that studies and develops theories, methods, technology, and application systems for simulating the extension and expansion of human intelligence. A mainstream technology for the AI is deep neural network (DNN) for big data processing. DNN is a computing network model inspired by the signal processing process of the human brain and has already achieved major applications ranging from language translation, image recognition, cancer diagnosis to fundamental science, and has greatly improved machine learning performance in related fields. However, the computational performance that AI demands from processors has grown rapidly. A photonic neural network (PNN) is a remarkable analogue artificial intelligence accelerator that computes using photons instead of electrons at low latency, high energy efficiency and high parallelism. An effective training approach is one of the most critical aspects to ensure the reliability and efficiency of DNN.

The DNNs constructed using software on a digital electronic computer are generally trained using the backpropagation algorithm. Such a training mechanism provides a basis for the in silico training of photonic DNNs, which establishes PNN physical models in computers to simulate PNN physical systems, trains PNN physical models through backpropagation and deploys the trained PNN physical model parameters to the PNN physical systems. However, inherent systematic errors of analogue computing from different sources (for example, geometric and fabrication errors) cause a deviation between the in silico-trained PNN physical models and the PNN physical systems, resulting in performance degeneration during deployment of the PNN physical models in the PNN physical systems.

### SUMMARY

The present application provides a dual adaptive training method of photonic neural networks (PNN) and associated components, which solves a problem that the network training method in the prior art cannot adapt to continuously accumulated systematic errors in PNN, allows the PNN physical model to adapt to significant systematic errors during the training and the PNN physical model to maintain high performance when being deployed in the PNN physical system.

The dual adaptive training method of the photonic neural networks according to the present application includes constructing a PNN numerical model including a PNN physical model and a systematic error prediction network model, where the PNN physical model is an error-free ideal PNN physical model of a PNN physical system, the systematic error prediction network model is an error model of the PNN physical system; determining measurement values of the PNN physical system and measurement values of the PNN numerical model, where the measurement values of the PNN physical system include final output values of the PNN physical system, and the measurement values of the PNN numerical model include final output values of the PNN numerical model; determining a similarity loss function based on comparison results between the measurement values of the PNN physical system and the measurement values of the PNN numerical model; determining a task loss function based on fused results of the measurement values of the PNN physical system and the measurement values of the PNN numerical model; and optimizing and updating parameters of the PNN numerical model based on the similarity loss function and the task loss function for in situ training of the PNN physical model.

In the dual adaptive training method of the photonic neural networks according to the present application, the measurement values of the PNN physical system further include optionally measured internal states from the PNN physical system, and the measurement values of the PNN numerical model further include optionally extracted internal states from the PNN numerical model.

In the dual adaptive training method of the photonic neural networks according to the present application, determining the measurement values of the PNN physical system and the measurement values of the PNN numerical model includes: optically encoding each training sample to obtain input optical signals: inputting the input optical signals into the PNN physical system, measuring the final output values of the PNN physical system and the internal states of the PNN physical system to obtain the measurement values of the PNN physical system: digitally encoding each training sample to obtain input digital signals: and inputting the input digital signals into the PNN numerical model, extracting the final output values of the PNN numerical model and the internal states of the PNN numerical model to obtain the measurement values of the PNN numerical model.

In the dual adaptive training method of the photonic neural networks according to the present application, determining the similarity loss function based on comparison results between the measurement values of the PNN physical system and the measurement values of the PNN numerical model includes: determining, based on a comparison result between the internal states and the final output values of the PNN physical system and the internal states and final output values of the PNN numerical model, that the similarity loss function L_{S} in a unitary optimization mode is:

$${L}_{s} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2}$$

where P={Pₙ}ₙ₌₁^{N} are the measurement values of the PNN physical system, S={Sₙ}ₙ₌₁^{N} are the measurement values of the PNN numerical model in a unitary optimization mode, N is an integer greater than or equal to 1 and is the total number of internal states and final output values that can be obtained through measurement in the PNN physical system, n represents an integer between 1 and N (1<=n<=N), Pₙ represents the n-th measurable internal state or final output of the PNN physical system, Sₙ represents the internal states or final output values at a position corresponding to Pₙ in the PNN numerical model, Iₘₛₑ is the mean square error (MSE) function, and αₙ is a coefficient to weight the n-th MSE function.

In the dual adaptive training method of the photonic neural networks according to the present application, determining the task loss function based on the fused results of the measurement values of the PNN physical system and the measurement values of the PNN numerical model includes: determining, based on fused results of the final output values of the PNN physical system and final output values of the PNN numerical model, that the task loss function Lₜ is:

$${L}_{t} ( {\vert {F}_{N} ( {P}_{N} , {S}_{N} ) \vert}^{2} , T ) ;$$

where T represents a task target; Lₜ is the task loss function; F_{N} (P_{N}, S_{N}) represents the fused results.

In the dual adaptive training method of the photonic neural networks according to the present application, optimizing and updating parameters of the PNN numerical model based on the similarity loss function and the task loss function for in situ training of the PNN physical model includes: minimizing the similarity loss function L_{S} in a unitary optimization mode to update parameters of the systematic error prediction network model;

$${min}_{Λ} \{ {L}_{S} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2} \}$$

where Λ are learnable parameters of the systematic error prediction network model;
minimizing the task loss function Lₜ to update the parameters of the PNN physical model;

$${min}_{Ω} \{ {L}_{t} ( {\vert {F}_{N} ( {P}_{N} , {S}_{N} ) \vert}^{2} , T ) \}$$

$${\{ {F}_{N} ( {P}_{N} , {S}_{N} ) = \sqrt{{P}_{n}} exp ( j {Φ}_{{S}_{n}} ) \}}_{n = 1}^{N} ;$$

where Ω are learnable parameters of the PNN physical model; j is an imaginary unit, Φ_{S}_{ₙ} is the phase of the complex optical field signal; when the PNN physical model does not converge, steps of minimizing the similarity loss function L_{S} in the unitary optimization mode to update the parameters of the systematic error prediction network model and minimizing the task loss function Lₜ to optimize and update the parameters of the PNN numerical model are performed to update the parameters of the PNN physical model for in situ training of the PNN physics model.

In the dual adaptive training method of the photonic neural networks according to the present application, determining the similarity loss function based on comparison results between the measurement values of the PNN physical system and the measurement values of the PNN numerical model includes: determining, based on comparison results between the final output values and internal states of the PNN physical system and the final output values and internal states of the PNN numerical model that the similarity loss function in a separable optimization mode is:

$${L}_{s , n} ( {P}_{n} , {\vert {\overline{S}}_{n} \vert}^{2} ) = {l}_{m s e} ( {P}_{n} , {\vert {\overline{S}}_{n} \vert}^{2} ) = {‖ {P}_{n} - {\vert {\overline{S}}_{n} \vert}^{2} ‖}_{2}^{2} ;$$

where N is an integer greater than or equal to 1, n represents an integer between 1 and N (1<=n<=N), and Pₙ represents the n-th measurable internal states or final output values of the PNN physical system, S̅ₙ represents the internal states or final output values at a position corresponding to Pₙ of the PNN numerical model in the separable optimization mode.

In the dual adaptive training method of the photonic neural networks according to the present application, the PNN physical system is a diffractive photonic neural network (DPNN) physical system or a Mach-Zehnder interferometer (MZI)-based photonic neural network (MPNN) physical system, and the DPNN physical system is a DPNN physical system with a single block or a DPNN physical system with multiple blocks.

The present application further provides an electronic device, including a memory storing a computer program and a processor, the computer program, when executed by the processor, causes the processor to implement steps of the dual adaptive training method of the photonic neural networks.

The present application further provides a non-transitory computer-readable storage medium having stored thereon a computer program that is executed by a processor to implement steps of the dual adaptive training method of the photonic neural networks.

The dual adaptive training method of the photonic neural networks according to the present application includes constructing a PNN numerical model including a PNN physical model and a systematic error prediction network model, where the PNN physical model is an error-free ideal PNN physical model of a PNN physical system, the systematic error prediction network model is the error model of the PNN physical system; determining measurement values of the PNN physical system including final output values of the PNN physical system, and measurement values of the PNN numerical model including final output values of the PNN numerical model; determining a similarity loss function and a task loss function based on comparison results between and fused results of the measurement values of the PNN physical system and the measurement values of the PNN numerical model; optimizing and updating parameters of the PNN numerical model based on the similarity loss function and the task loss function for in situ training of the PNN physical model. By the training method above, the PNN physical model can adapt to significant systematic errors during the training and the PNN physical model maintains high performance when deployed in the PNN physical system.

### BRIEF DESCRIPTION OF DRAWINGS

In order to more clearly illustrate technical solutions in the present application or the prior art, the drawings needed to be used in the descriptions of the embodiments or the prior art will be briefly introduced below. The drawings in the following description are some embodiments of the present application, and other drawings can be obtained according to the drawings for those skilled in the art without any creative work.

FIG. 1 is a schematic flowchart of a dual adaptive training method of photonic neural networks according to an embodiment of the present application;

FIG. 2 is a schematic diagram of a basic principle of dual adaptive training (DAT) for training PNN with systematic errors according to an embodiment of the present application;

FIG. 3 is a schematic diagram of training diffractive photonic neural network (DPNN) with DAT according to an embodiment of the present application;

FIG. 4 is a schematic structural diagram of a systematic error prediction network (SEPN) according to an embodiment of the present application;

FIG. 5 is schematic diagram of performance results of training DPNN under joint systematic errors according to an embodiment of the present application;

FIG. 6 is a schematic diagram of training Mach-Zehnder interferometer (MZI)-based photonic neural network (MPNN) with DAT according to an embodiment of the present application;

FIG. 7 is schematic diagram of performance results of training MPNN under joint systematic errors according to an embodiment of the present application;

FIG. 8 is a schematic diagram of the process of optimizing DPNN with DAT measuring internal states according to an embodiment of the present application;

FIG. 9 is a schematic diagram of the process of optimizing MPNN with DAT without measuring internal states according to an embodiment of the present application;

FIG. 10 is a first schematic structural diagram of a DPNN physical system for verifying a DAT method according to an embodiment of the present application;

FIG. 11 is a second schematic structural diagram of a DPNN physical system for verifying a DAT method according to an embodiment of the present application;

FIG. 12 is a schematic diagram showing experimental results of the DAT algorithm implemented on the DPNN physical system according to an embodiment of the present application: and

FIG. 13 is a schematic structural diagram of an electronic device according to an embodiment of the present application.

### DETAILED DESCRIPTION OF THE EMBODIMENTS

In order to illustrate the objects, solutions and advantages of the application, the solutions in present the application will be described clearly and completely below in combination with the drawings in the application. The described embodiments are part of the embodiments of the application, not all of them.

All other embodiments obtained by a person of ordinary skill in the art based on the embodiments of the present application without any creative work belong to the scope of the present application.

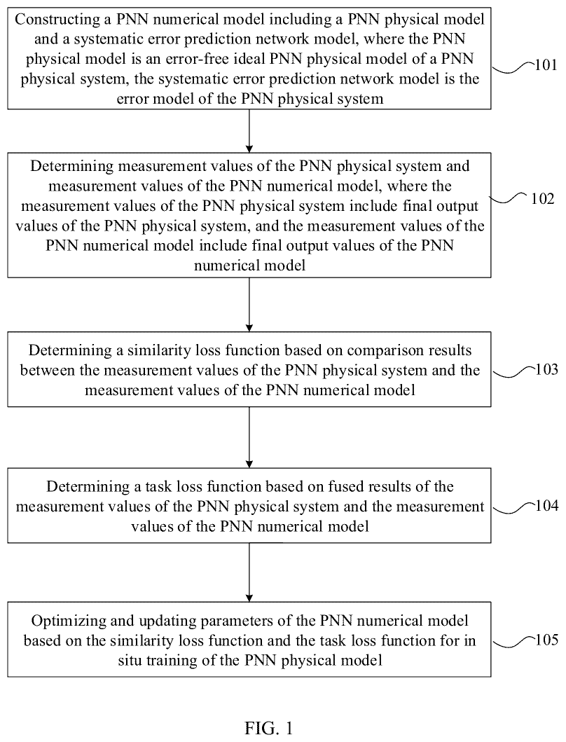

Referring to FIG. 1, which is a schematic flowchart of a dual adaptive training method of photonic neural networks according to an embodiment of the present application.

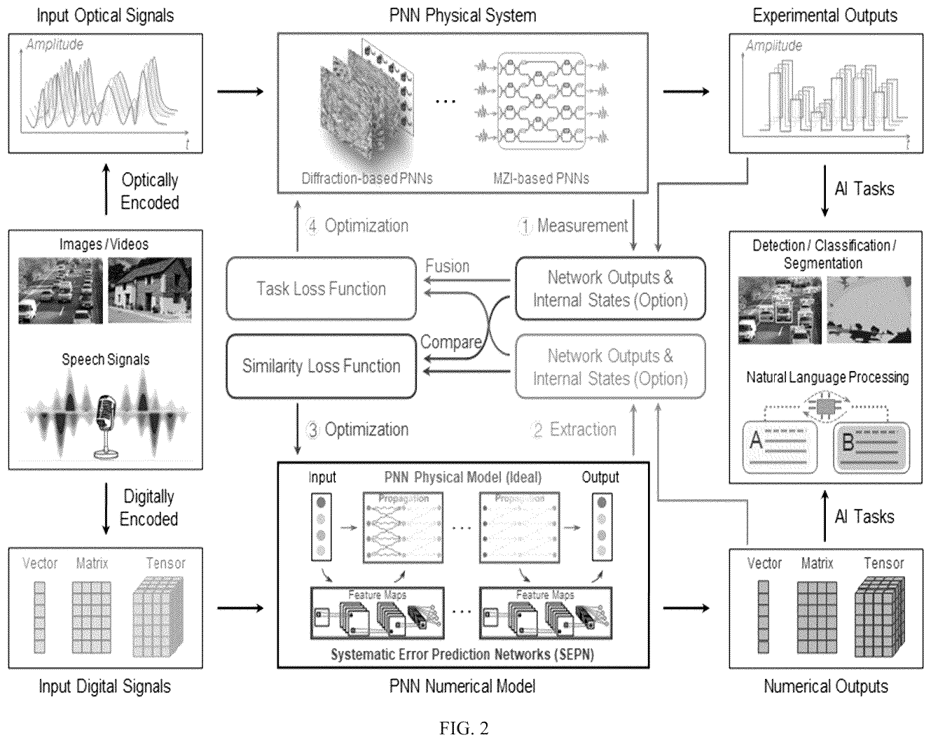

Referring to FIG. 2, which is a schematic diagram of a basic principle of DAT for training PNN with systematic errors according to an embodiment of the present application.

The present application provides a dual adaptive training method of photonic neural networks (PNN), including:
step 101: constructing a PNN numerical model including a PNN physical model and a systematic error prediction network model, where the PNN physical model is an error-free ideal PNN physical model of a PNN physical system, the systematic error prediction network model is an error model of the PNN physical system;
step 102: determining measurement values of the PNN physical system and measurement values of the PNN numerical model, where the measurement values of the PNN physical system include final output values of the PNN physical system, and the measurement values of the PNN numerical model include final output values of the PNN numerical model;
step 103: determining a similarity loss function based on comparison results between the measurement values of the PNN physical system and the measurement values of the PNN numerical model;
step 104: determining a task loss function based on fused results of the measurement values of the PNN physical system and the measurement values of the PNN numerical model; and
step 105: optimizing and updating parameters of the PNN numerical model based on the similarity loss function and the task loss function for in situ training of the PNN physical model.

Artificial intelligence (AI), powered by deep neural networks (DNNs), uses brain-inspired information processing mechanisms to approach human-level performance in complex tasks and has already achieved major applications ranging from language translation, image recognition and cancer diagnosis to fundamental science. The vast majority of AI algorithms have been implemented via digital electronic computing platforms such as graphics processing units (GPU) and tensor processing units (TPU) to support their major computational requirements. However, the computational performance that AI demands from processors has grown rapidly, greatly exceeding the development of digital electronic computing imposed by Moore's law and the upper limit of computing energy efficiency. Constructing photonic neural network systems for AI tasks with analogue photonic computing has attracted increasing attention and is expected to be the next-generation AI computing modality due to its advantages of low latency, high bandwidth and low power consumption. The fundamental characteristic of photons and the principle of light-matter interactions (for example, diffraction and interference based on free-space optics or integrated photonic circuits) have been used to implement various neuromorphic photonic computing architectures such as convolutional neural networks, spiking neural networks, recurrent neural networks and memristor-based reservoir computing networks.

An effective training approach is one of the most critical aspects to ensure the reliability and efficiency of DNN. The DNNs constructed using software on a digital electronic computer are generally trained using the backpropagation algorithm. Such a training mechanism provides a basis for the in silico training of photonic DNNs, which establishes PNN physical models in computers to simulate PNN physical systems, trains PNN physical models through backpropagation and deploys the trained PNN physical model parameters to the PNN physical systems. However, inherent systematic errors of analogue computing from different sources (for example, geometric and fabrication errors) cause a deviation between the in silico-trained PNN physical models and the PNN physical systems, resulting in performance degeneration during deployment of the PNN physical models in the PNN physical systems. To adapt to systematic errors, researchers help train PNN physical models by measuring actual physical quantities on the PNN physics system, also known as in situ training methods. Those in situ training methods have drawn increasing attention and been researched. Nevertheless, the traditional in situ training methods still confront great challenges in training large-scale PNNs with major systematic errors, which hinders the construction of advanced architectures and limits the model performance in performing complex AI tasks. The reasons for this are mainly due to the inaccurate gradient calculations during the backpropagation caused by the imprecise modelling of PNN physical systems, the requirement of extensive system measurements with layer-by-layer training processes, resulting in the extremely high computational complexity, and the requirement of additional hardware configurations to generate complex optical fields for calculating gradients during backward propagation, resulting in high hardware cost.

To solve the problems in the prior art, the present application provides a dual adaptive training (DAT) method for large-scale PNN in which a dual adaptive backpropagation training process is constructed to end-to-end optimize the PNN physical models and enable the PNN physical models to adapt to significant systematic errors without additional hardware configurations for generation and propagation of backward optical fields. In an embodiment, to precisely model the PNN physical system, a PNN numerical model constructed in a digital computer includes a PNN physical model and a systematic error prediction network (SEPN) model, to respectively model a photonic computing process and inherent systematic errors and a task-similarity loss function joint optimization approach based on the dual backpropagation training is developed. The PNN physical model is an error-free ideal PNN physical model in a computer of a PNN physical system, the SPEN model is the error model of the PNN physical system. In order to facilitate the learning of systematic errors of PNN layers, SEPN can be connected to the PNN physical model in the manner of residual connections. Each SEPN module can be configured as a complex-valued mini-UNet to guarantee its learning capacity for adapting the systematic errors of the PNN layers. In addition, the PNN physical system refers to the actual physical optical system with errors. The PNN physical model is used to approximate or even accurately model the PNN physical system. The DAT iteratively updates the network parameters of the PNN physical model and SEPNs in an end-to-end optimization form for each input training sample. With the training of SEPNs to characterize the inherent systematic errors, the DAT establishes high similarity mapping between the PNN numerical models and physical systems, leading to highly accurate gradient calculation for training the PNN numerical models. Each training sample can be optically and digitally encoded as the input to the PNN physical system and the PNN numerical model respectively and perform forward propagation. The measurement values obtained from the PNN physical system and the measurement values obtained from the PNN numerical model can be compared to obtain the similarity loss function and can be fused to obtain the task loss function. The measurement values of the PNN physical system include the final output values of the PNN physical system and the measurement values of the PNN numerical model includes the final output values of the PNN numerical model. After training, the PNN physical model is directly deployed on the PNN physical system and can adapt to significant systematic errors from various sources. On this base, the DAT therefore supports large-scale PNN training and mitigates the requirement of high-precision fabrication and system configurations.

By the dual adaptive training method of the photonic neural networks according to the present application, the PNN physical model can adapt to significant systematic errors during the training and the PNN physical model maintains high performance when deployed in the PNN physical system.

Based on the embodiment above, as an embodiment, the measurement values of the PNN physical system further include optionally measured internal states from the PNN physical system and the measurement values of the PNN numerical model include optionally extracted internal states from the PNN numerical model.

In order to further improve the training performance of the PNN numerical model with DAT, especially under more severe systematic errors while balancing the measurement cost, in the embodiment, the internal states {P₁, P₂, . . . , P_{N -1}} (i.e., the output of each layer) of the PNN physical system and the internal states {S₁, S₂, . . . , S_{N-1}} of the PNN numerical model can be optionally measured, the similarity loss function and task loss function can be determined, respectively, based on comparison results and fused results of the final output values and internal states of the PNN physical system and the final output values and internal states of the PNN numerical model; the parameters of the PNN numerical model can be updated based on the similarity loss function and task loss function for training the PNN physical model. The trained PNN physical model can better adapt to larger systematic errors and has higher performance when deployed in the PNN physical system.

As an embodiment, determining the measurement values of the PNN physical system and the measurement values of the PNN numerical model includes: optically encoding each training sample to obtain input optical signals: inputting the input optical signals into the PNN physical system, measuring the final output values of the PNN physical system and the internal states of the PNN physical system to obtain the measurement values of the PNN physical system: digitally encoding each training sample to obtain input digital signals: and inputting the input digital signals into the PNN numerical model, extracting the final output values of the PNN numerical model and the internal states of the PNN numerical model to obtain the measurement values of the PNN numerical model.

In order to determine the measurement values of the PNN physical system and the measurement values of the PNN numerical model, in the present embodiment, each training sample is optically encoded to obtain I, and I is input to the PNN physical system composed of N-layer networks to perform forward propagation and the final output values P_{N} and internal states {P₁, P₂, . . . , P_{N -1}} are obtained. All of the measurements {P₁, P₂, . . . , P_{N}} may be set as optical field intensities (that is, the square of the absolute value of complex optical fields) to facilitate the measurement. The same training sample I is digitally encoded and input into the PNN numerical model to extract the internal states {S₁, S₂, . . . , S_{N-1}} and the final output values S_{N}. Different from the counterpart physical measurement values Pₙ, Sₙ is set as the complex optical fields with amplitude \sqrt{Sₙ} and phase @s, to facilitate the formulation of the DAT process. Different from the physical system, it is easy to extract the complex optical fields from the numerical model. If the systematic errors can be perfectly characterized with SEPNs, it can be known that |Sₙ|²=Pₙ. Therefore, the measurement values of the PNN physical system and the measurement values of the PNN numerical model can be accurately obtained using the method of the present embodiment.

As an embodiment, determining the similarity loss function based on comparison results between the measurement values of the PNN physical system and the measurement values of the PNN numerical model includes: determining, based on a comparison result between the internal states and the final output values of the PNN physical system and the internal states and final output values of the PNN numerical model, that the similarity loss function L_{S} in a unitary optimization mode is:

$${L}_{s} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2} ;$$

where P={Pₙ}ₙ₌₁^{N} are the measurement values of the PNN physical system, S={Sₙ}ₙ₌₁^{N} are the measurement values of the PNN numerical model in a unitary optimization mode, N is the total number of internal states and final output values that can be obtained through measurement in the PNN physical system, n represents an integer between 1 and N (1<=n<=N), Pₙ represents optical field intensities corresponding to the n-th measurable internal state of the PNN physical system or the final output values, Sₙ represents the complex optical field corresponding to the internal state at the position corresponding to Pₙ of the PNN numerical model or the final output values, when n=N, P_{N} is the final output values of the PNN physical system, S_{N} is the final output values of the PNN numerical model, Iₘₛₑ is the mean square error (MSE) function, and an is a coefficient to weight the n-th MSE function. In some embodiments, the specific value of an can be set by technicians based on actual experimental data or experience.

In an embodiment, determining the task loss function based on the fused results of the measurement values of the PNN physical system and the measurement values of the PNN numerical model includes: determining, based on fused results of the final output values of the PNN physical system and final output values of the PNN numerical model, that the task loss function Lₜ is:

$${L}_{t} ( {\vert {F}_{N} ( {P}_{N} , {S}_{N} ) \vert}^{2} , T ) ;$$

where T represents a task target; Lₜ is the task loss function; F_{N} (P_{N}, S_{N}) represents the fused results.

In addition, it should be noted that the functional form of Lₜ is determined by the specific task. When the task is an image classification task, Lₜ can be selected as the cross-entropy loss function. For other tasks, the Lₜ may have different selections. For example, for image reconstruction tasks, the MSE loss function needs to be used, which is not specifically limited in the present application.

In an embodiment, optimizing and updating parameters of the PNN numerical model based on the similarity loss function and the task loss function for in situ training of the PNN physical model includes: minimizing the similarity loss function L_{S} in a unitary optimization mode to update parameters of the systematic error prediction network model;

$${min}_{Λ} \{ {L}_{S} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2} \}$$

where Λ are learnable parameters of the systematic error prediction network model;
minimizing the task loss function Lₜ to update the parameters of the PNN physical model;

$${min}_{Ω} \{ {L}_{t} ( {\vert {F}_{N} ( {P}_{N} , {S}_{N} ) \vert}^{2} , T ) \} ;$$

$${\{ {F}_{N} ( {P}_{N} , {S}_{N} ) = \sqrt{{P}_{n}} exp ( j {Φ}_{{S}_{n}} ) \}}_{n = 1}^{N} ;$$

where Ω are learnable parameters of the PNN physical model; j is an imaginary unit, Φ_{S}_{ₙ} is the phase of the complex optical field signal;
when the PNN physical model does not converge, steps of minimizing the similarity loss function L_{S} in the unitary optimization mode to update the parameters of the systematic error prediction network model and minimizing the task loss function Lₜ to optimize and update the parameters of the PNN numerical model are performed to update the parameters of the PNN physical model for in situ training of the PNN physics model.

In the present embodiment, parameters of the SEPN of the PNN numerical model can be optimized by minimizing the similarity loss function, where the similarity loss function in the unitary optimization mode is L_{S}. In this process, the parameters of the PNN physical model are fixed, the gradients of L_{S} with respect to A are calculated during the backpropagation, and a gradients descent is performed to update all parameters of the SEPN. The similarity loss function in the unitary optimization mode aims to optimize the SEPN to minimize the deviation between the measurement values of the physical system and the measurement values of the numerical model, to accurately model the PNN physical system with the PNN numerical model. The aforementioned training step for SEPNs is referred to as a unitary optimization mode, as all of the parameters of the SEPNs are optimized with a unitary loss function. Similarly, parameters of the SEPN of the PNN physical model can be optimized by minimizing the task loss function Lₜ, and deployed to the physical system. F_{N} (P_{N}, S_{N}) represents the fused results, which replaces the amplitude in the PNN numerical model with the amplitude measured by the PNN physical system. Furthermore, such fusion processes are applied for not only the final output values, but also the internal states, to maintain the interactions between the PNN numerical model and the PNN physical system, and {F_{N} (P_{N}, S_{N})=\sqrt{Pₙ}exp(jΦ_{S}_{ₙ})}ₙ₌₁^{N} is obtained. During this process, the parameters of SEPN are fixed, and the fused network output and internal states are used to calculate the gradients of Lₜ with respect to the physical system parameters $2 to update parameters of the PNN physical model. The optimization of the task loss function aims to train the PNN physical model under systematic errors so that the PNN physical system deployed with physical parameters £2 can perform the target tasks.

The above training steps are repeated for all training samples to minimize the loss function until the model converges, to obtain PNN physical model parameters that can be directly deployed in the PNN physical system. Such training process is referred to as a dual backpropagation training because the gradient calculations for updating the parameters of the PNN physical model and SEPNs rely on each other. Furthermore, the training of PNN physical models facilitates the training of SEPN and vice versa. On the one hand, the optimization of the PNN physical model helps SEPN characterize the inherent systematic errors of the PNN physical model under specific tasks. On the other hand, the optimization of SEPN parameters helps to accurately model systematic errors, thereby improving the performance of tasks performed by PNN physical models when deployed in PNN physical systems. Furthermore, the data fusion operation allows the PNN physical model to further adapt to the systematic errors and accelerate convergence, especially when SEPN does not fully characterize the systematic errors during the optimization process. These underlying mechanisms ensure the effectiveness and convergence of the proposed DAT.

As an embodiment, determining the similarity loss function based on comparison results between the measurement values of the PNN physical system and the measurement values of the PNN numerical model includes: determining, based on comparison results between the final output values and internal states of the PNN physical system and the final output values and internal states of the PNN numerical model that the similarity loss function in a separable optimization mode is:

$${L}_{s , n} ( {P}_{n} , {\vert {\overline{S}}_{n} \vert}^{2} ) = {l}_{m s e} ( {P}_{n} , {\vert {\overline{S}}_{n} \vert}^{2} ) = {‖ {P}_{n} - {\vert {\overline{S}}_{n} \vert}^{2} ‖}_{2}^{2} ;$$

where N is the total number of internal states and final output values that can be obtained through measurement in the PNN physical system, n represents an integer between 1 and N (1<=n<=N), Pₙ represents optical field intensities corresponding to the n-th measurable internal state of the PNN physical system or the final output values, Sₙ represents the complex optical field corresponding to the internal state at the position corresponding to Pₙ of the PNN numerical model or the final output values in the separable optimization mode.

When the internal states are measured, the parameters of SEPN can also be updated using the separable optimization mode. In the present embodiment, all SEPNs are divided into several groups and each group is optimized independently. For an N-layer PNN with input I, the internal states and final output values {Pₙ}ₙ₌₁^{N} can be measured from the physical system, and its corresponding values {S̅ₙ}ₙ₌₁^{N} in the physical model can also be extracted. The {S̅ₙ}ₙ₌₁^{N} here are not the {Sₙ}ₙ₌₁^{N} mentioned in the previous embodiment and obtained through unitary inference in the numerical model. In the separable optimization mode, {Sₙ}ₙ₌₁^{N} is not suitable for matching with {Pₙ}_{N=1}^{N}, because the inputs for obtaining Sₙ and Pₙ may not match. In order to solve this problem, {S̅ₙ}ₙ₌₁^{N} are obtained through separable inference in the numerical model. The PNN numerical model is divided into N groups, and each group corresponds to some SEPNs. For the n-th group, its input is replaced with the measurement values in the corresponding physical system, and the replaced input is used for forward inference of the n-th group to obtain Sₙ. This process is performed for all groups in sequence, and finally {S̅ₙ}ₙ₌₁^{N} can be obtained. It is worth mentioning that {Sₙ}ₙ₌₁^{N} is still essential in the separable optimization mode, because it needs to be used in the update process of the PNN physical model. In the above process, a situation that all internal states are measured is assumed, and the process can be easily extended to the case where some internal states are measured.

In order to optimize SEPN in the separable mode, the PNN numerical model is divided into N groups, where the n-th group corresponds to the paired data (Pₙ, S̅ₙ) and a certain number of SEPNs are included in the group. For example, a multi-block diffractive photonic neural network (DPNN) can be divided into seven groups, where the n-th group manages three SEPNs in the n-th block. A is used to represent the parameters of SEPN in the n-th group, and L_{s,n} is used to represent the similarity loss function of the n-th group, then:

$${L}_{s , n} ( {P}_{n} , {\vert {\overline{S}}_{n} \vert}^{2} ) = {l}_{m s e} ( {P}_{n} , {\vert {\overline{S}}_{n} \vert}^{2} ) = {‖ {P}_{n} - {\vert {\overline{S}}_{n} \vert}^{2} ‖}_{2}^{2} ;$$

during the process of updating SEPN, the parameters of the PNN physical model are fixed. For all n belonging to [1, N], the gradient of each L_{s,n} with respect to Λₙ is calculated and used to separately update the SEPN within the n-th group.

In an embodiment, the PNN physical system is a DPNN physical system or a Mach-Zehnder interferometer (MZI)-based photonic neural network (MPNN) physical system, and the DPNN physical system is a DPNN physical system with a single block or a DPNN physical system with multiple blocks.

The PNN physical system may be a DPNN physical system or a MPNN physical system. In the present embodiment, the effectiveness of DAT is validated by applying it for training large-scale DPNNs and MPNNs.

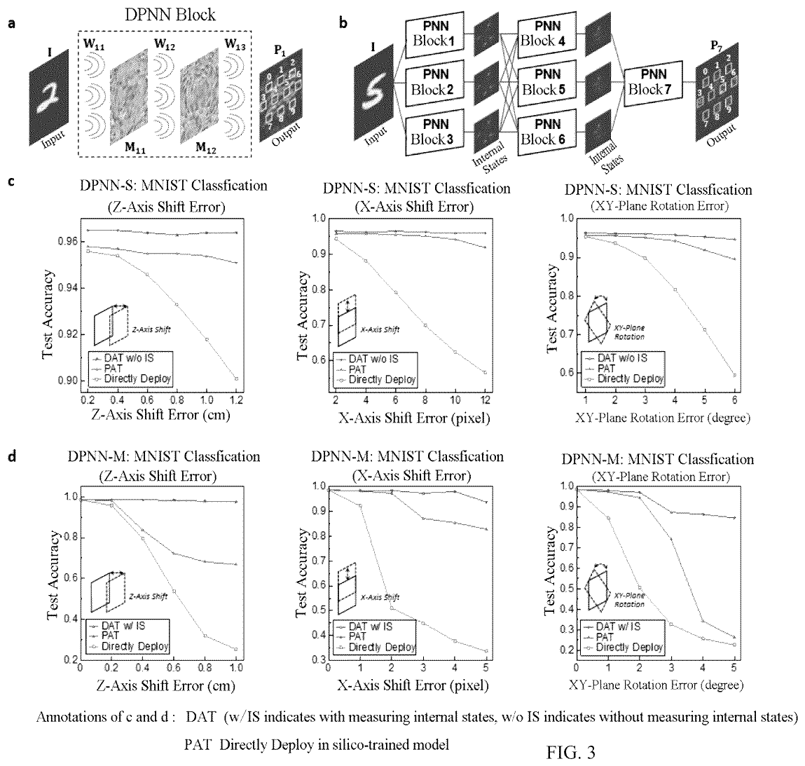

Referring to FIG. 3, which is a schematic diagram of training diffractive photonic neural network (DPNN) with DAT according to an embodiment of the present application.

Two types of DPNN architectures are constructed in the present embodiment: a DPNN with a single block (DPNN-S) and a DPNN with multiple blocks (DPNN-M). The DPNN-S includes two cascading phase modulation layers, the corresponding transformation matrices are M₁₁ and M₁₂, and optical intensities are measured at the output plane. An output layer of the DPNN-S records the output optical field intensity P₁ whose input is I. In an embodiment, the phase modulation layer can modulate the phase of the input optical field, and generate a secondary wave source through optical diffraction and propagate to the next phase modulation layer or output plane for intensity measurement. Therefore, the forward propagation of DPNN-S has three free space diffraction processes, corresponding to three diffraction matrices W₁₁, W₁₂ and W₁₃. Therefore, the mathematical model of forward propagation of the DPNN-S can be defined as P₁=|W₁₃M₁₂W₁₂M₁₁W₁₁I|². To further demonstrate the effectiveness of the proposed method on DPNN with larger network scale, a DPNN with multiple blocks (DPNN-M) is constructed, which contains seven PNN blocks, forming a multi-channel hierarchically interconnected structure. Each PNN block of DPNN-M is the same as the counterpart in DPNN-S, but their parameters are independent and not shared. DPNN-M has been demonstrated to achieve higher model performance yet inevitably accumulates more extensive systematic errors layer by layer with the more complicated network structure.

For both DPNN-S and DPNN-M, the phase modulation coefficients are set as learnable parameters and thus can be optimized through end-to-end network training. In addition to the function of recording intensity, the photodetector on the output plane can also be regarded as a nonlinear function in the network to improve network performance. The final output intensity approximates the task goal by minimizing the task loss function Lₜ. All SEPNs introduced for DPNN-S and DPNN-M share the same network architecture. Each SEPN was constructed as a complex-valued mini-UNet to extract hierarchical features, which is simpler and lighter than standard UNet. The trainable parameters of a SEPN module and UNet are 26,800 and 7,765,442, respectively, with a parameter ratio of 0.345%.

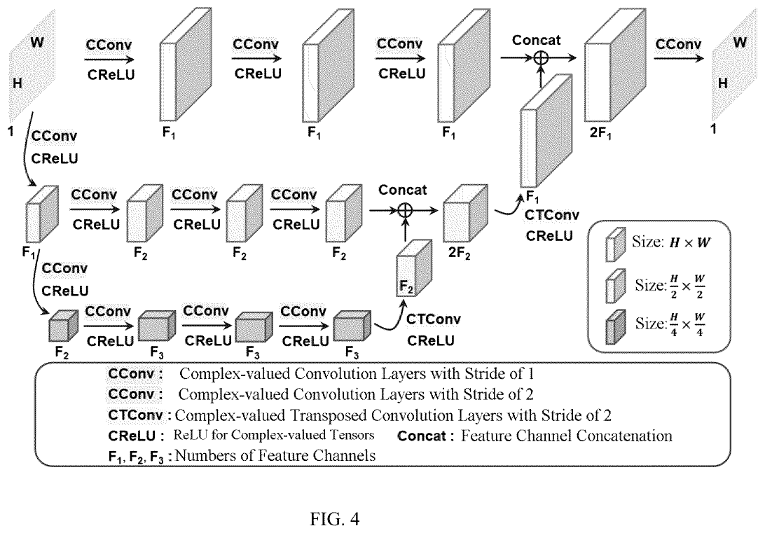

Referring to FIG. 4, which is a schematic structural diagram of a systematic error prediction network (SEPN) according to an embodiment of the present application.

All SEPNs share the same architecture and each SEPN was designed as a complex-valued mini-UNet with hierarchically interconnected structures to extract multiscale features, which is simpler and lighter than standard UNet. To match the complex-valued computation of DPNNs and MPNNs, complex-valued weights are adopted to construct the SEPNs. Each complex-valued convolution layer (CConv) is set to a size of 5×5 in the DPNN and 3×3 in the MPNN, followed by a complex-valued ReLU (CReLU) except for the last convolution layer. The CReLU refers to performing ReLU operations on the real part and imaginary part of the input complex number respectively. For an input image with a size of H×W, CConvs with stride 2 are introduced to downscale the size to H/2×W/2 and H/4×W/4, while two complex-valued transposed convolution layers (CTConvs) with stride 2 are utilized to upsample the size from H/4×W/4 to H/2×W/2 and from H/2×W/2 to H×W. Other CConvs plotted within blue blocks have a stride of 1 and are used to perform convolution operations that maintain the scale unchanged, but may change the feature channel numbers.

The total number of learnable parameters for a SEPN can be calculated as: k²(4F₁+2F₁²+4F₁F₂+2F₂²+2F₂F₃+2F₃²), where F₁, F₂, F₃ represent the numbers of feature channels and k represents the convolutional kernel size. In the experiments for DPNN-S and DPNN-M, F₁=4, F₂=8, F₃=16, and k=5; thus, the total parameter number is 26,800. As for the MPNN, two SEPNs with different scales are constructed. The lighter one is configured with F₁=4, F₂=6, F₃=8 and k=3 with a parameter number of 3960, and F₁, F₂, F₃, k for the other are set to 4, 8, 16, 3 with a parameter number of 9,648. Compared with UNet with a total parameter number of 7,765,442, the SEPNs are lighter and can be efficiently optimized.

DPNN-S and DPNN-M are trained with DAT for Modified National Institute of Standards and Technology (MNIST) and Fashion-MNIST (FMNIST) classification tasks and four types of systematic errors that may occur in actual systems are considered: a z-axis shift error, an x-axis shift error, an xy-plane rotation error and phase shift errors. The first three types of errors are mainly geometric errors caused by inaccurate alignment. It is assumed that each layer contains errors with the same amount. For example, setting the X-axis offset error to 1 pixel means that for the DPNN-S, both phase modulation layers and the last output plane are shifted upward by 1 pixel relative to the previous layer, the output is shifted upward by 3 pixels relative to the input; for the DPNN-M, it means that the output is shifted upward by 9 pixels relative to the input. In addition, the phase shift error is modeled using a normal distribution with a mean value of 0 and a standard deviation of σ. This error is mainly caused by the imperfection of the phase modulation device. The classification performance of the DPNN model is evaluated under individual and joint systematic errors to verify the effectiveness of DAT in various scenarios with different systematic error configurations.

As the phase shift errors have a minor effect on the classification performance of DPNN, only the impact of the phase shift error in the joint systematic errors on the performance is evaluated. For the MNIST classification tasks, the accuracy of the baseline model for an error-free system is 96.0% and 98.6% for DPNN-S and DPNN-M, respectively. For DPNN-S, DAT is implemented without measuring internal states and for DPNN-M, DAT is implemented with measuring internal states. Training SEPNs of the DPNN-M was conducted in a separable training mode. For both DPNN-S and DPNN-M, the test accuracy decreases rapidly when directly deploying the in silico-trained model to the physical system, and DPNN-M has a larger decrease in classification accuracy than DPNN-S due to the accumulation of more systematic errors due to a larger network scale. Physics-aware training (PAT) can correct the errors to some extent but is not effective when the errors become severe, especially for DPNN-M with a larger network scale. For example, according to FIGS. 3 and 4, PAT only improves the classification accuracy from 25.5% obtained by direct deployment, to 66.9% when the z-axis shift error is set to 1 cm, and fails when the xy-plane rotation error is set to 5° as it only improves the accuracy from 22.6% to 26.3%. By contrast, DAT outperforms PAT and dramatically eliminates the performance degradation caused by various systematic errors, making the classification accuracy be higher than that of the error-free model (for example, the results for DPNN-S with z-axis shift errors). These results validate the effectiveness and robustness of DAT for training DPNNs, especially demonstrating its powerful capacity to adapt to significant systematic errors from various sources in large-scale DPNN.

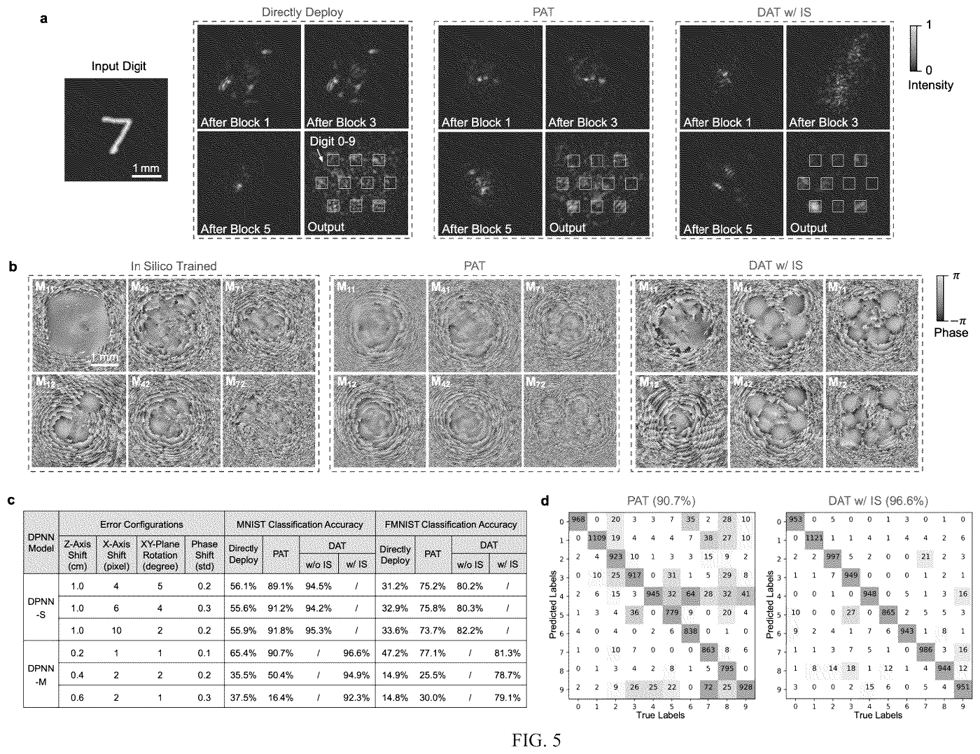

Referring to FIG. 5, which is schematic diagram of performance results of training DPNN under joint systematic errors according to an embodiment of the present application.

The performance of DAT in training DPNN-S and DPNN-M under joint systematic error is further evaluated. The table in FIG. 5 lists the results of MNIST and FMNIST classification under six joint systematic error configurations, in which both DPNN-S and DPNN-M are assigned with three configurations. A series of comparable or larger joint systematic errors are constructed to evaluate the performance of DPNN, which directly deploys the accuracy of the in silico-trained model. For the FMNIST classification, the baseline accuracy for an error-free system is 83.8% and 85.8% for DPNN-S and DPNN-M, respectively. In the joint systematic errors, DAT has also achieved better classification accuracy than PAT and significantly restored model performance, especially in larger-scale DPNN-M with more significant joint systematic errors. Under the last line of error configuration of DPNN-M, it can be found that PAT fails in the MNIST classification task because its accuracy is even lower than the directly deployed silico-trained model. By contrast, DAT has successfully trained DPNN-M and outperforms PAT. Compared with PAT, the accuracy was improved by 42.1% on average in the MNIST classification task and by 35.5% in the FMNIST classification task.

In the results of DPNN-M in the MNIST classification task, the error comes from the first column of the DPNN-M. Under the input of the test set digit “7”, the output intensity of the first, third, and fifth blocks, as well as the final output intensity, are visualized. It can be observed from the final output intensity that the directly deployed intensity distribution is scattered in various detector areas, resulting in erroneous identification; the PAT is slightly more concentrated. By contrast, DAT focuses the intensities in the correct detector area (lower left corner) and therefore correctly classifies the digit “7”. The phase modulation layers (first block, fourth block, and seventh block) obtained by the three training methods are visualized and the phase modulation layers obtained by PAT and DAT are completely different. The phase modulation layer generated by PAT has a relatively flat distribution of modulation values, while the distribution of DAT modulation values changes drastically. The confusion matrix summarizes the classification results for the 10,000 numbers in the test set, further demonstrating the effectiveness of DAT as it clusters matching pairs of predicted and true labels on the main diagonal.

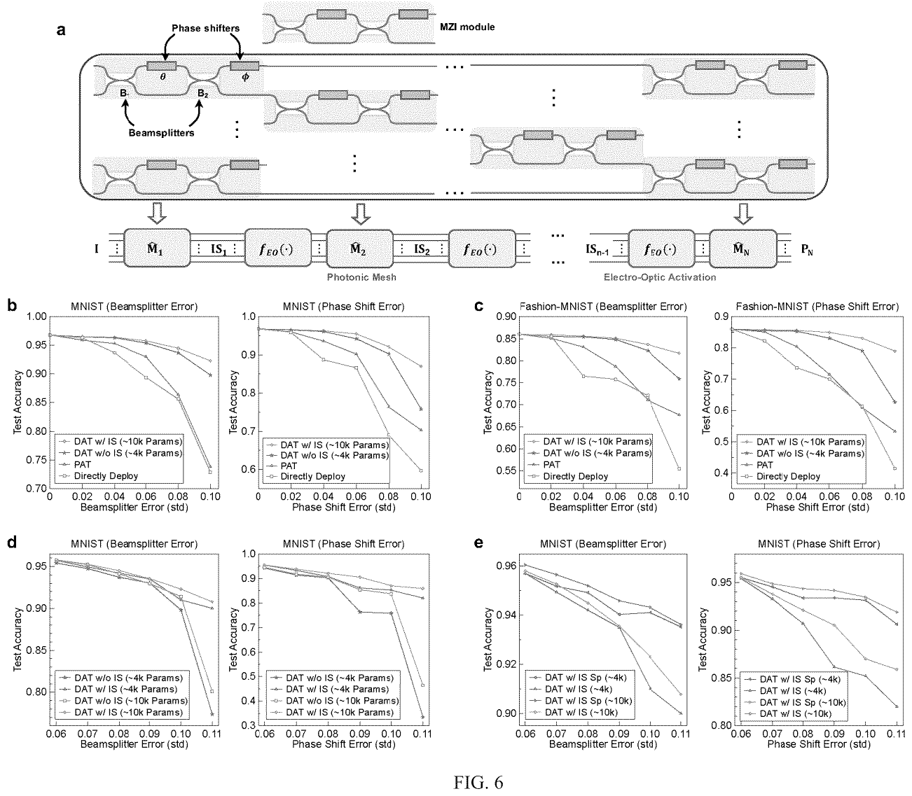

Referring to FIG. 6, which is a schematic diagram of training MPNN with DAT according to an embodiment of the present application.

N-layer MPNN consists of N photonic meshes and N−1 optoelectronic blocks between adjacent photonic meshes. Each photonic mesh is constructed with an array of Mach-Zehnder interferometer (MZI)s formed as a rectangular grid. Each MZI is a two-port optical component made of two 50:50 beamsplitters B₁, B₂ and two phase shifters with parameters ϕ, θ. In the n-th photonic mesh, the input optical field encoded in single-mode waveguides is multiplied with a unitary matrix \hat{M}ₙ realized by the n-th photonic mesh. The result is further processed with an optoelectronic block with the function fro for nonlinear processing, except for the final photonic mesh, to generate the output optical fields for the next layer. The output intensity of the last photonic mesh is measured by photodetectors and used for approximating the target result of a task. Like DPNNs, all SEPNs of the MPNN share the same complex-valued mini-UNet architecture, and yet are lighter than the counterparts utilized in DPNN training. Two SEPN with different scales (that is, 9,648 and 3,960 parameters, respectively) are constructed to evaluate the influence of the SEPN scale on the classification performance. Compared with the standard UNet with 7,765,442 parameters, the parameter ratios of the two SEPNs are 0.126% and 0.051%, respectively.

As MPNN is usually implemented in the form of an on-chip, the input data needs to be preprocessed to meet the requirements of its limited input ports. After Fourier transformation is performed on the input data, 64 Fourier coefficients in the center region of the Fourier-space representations were extracted as the input for MNIST and FMNIST classification. To match the input dimension, each photonic mesh is configured with 64×63/2=2016 MZIs containing 4032 beamsplitters, 2016 phase shifters with parameters ϕ, and 2016 phase shifters with parameters θ. The three-layer MPNN is constructed. Two types of systematic errors that occur in MZI, namely, beamsplitter error and phase shifter error caused by imperfect manufacture and inaccuracy optical modulation are considered. The beamsplitter error and phase shifter error are modeled using normal distributions with zero mean and standard deviation σ_{bs} and σₚₛ respectively. Furthermore, all devices contain errors of equal magnitude. For example, σₚₛ=0.1 means that all 4032 phase shifters have errors, and these error values follow a normal distribution with mean zero and standard deviation 0.1.

The results of DAT, PAT and directly deployed in silico-trained models are compared respectively. The legends labeled “˜10 k Params” or “˜4 k Params” represent 9,648 or 3,960 learnable parameters for each SEPN. DAT that measures internal states means that all internal states are measured. In the error-free MPNN system, the baseline classification accuracy is 96.8% for MNIST and 86.0% for FMNIST. Even if the internal states are not measured and the SEPN scale is relatively small, DAT outperforms the results of PAT and directly deployed in silico-trained models. By contrast, PAT faces training difficulties, especially under large systematic errors. For example, when σ_{bs}=0.08, the FMNIST classification accuracy using PAT is 71.1%, while the accuracy of directly deployed in silico-trained models is 72.1%, which is almost the same. At the same time, DAT measuring and without measuring internal states achieved classification accuracy of 83.7% and 82.3% respectively, indicating that SEPN more effectively predicts and characterizes systematic errors during DAT training. In the error configuration with the largest standard deviation, DAT without measuring internal states exceeds PAT by 16.0% (MNIST, σ_{bs}=0.1), 8.2% (MNIST, σₚₛ=0.1), 9.2% (FMNIST, σ_{bs}=0.1), 9.3% (FMNIST, σₚₛ=0.1), while the corresponding data for DAT measuring internal states were increased to 18.5%, 14.0%, 16.7% and 25.7%. The results demonstrate the excellent performance and robustness of DAT in training MPNN with significant systematic errors.

The impact of the SEPN scale on MNIST classification performance under different systematic error amounts was further evaluated. The standard range is 0.06 to 0.11. Considering whether the internal state is measured, the difference is not significant when the error is relatively small (from 0.06 to 0.08), and the performance gap becomes apparent as the standard deviation increases (from 0.09 to 0.11). Using SEPN of the same scale, DATs measuring internal states outperform DATs without measuring internal states, especially at large systematic errors. Although larger-scale SEPN helps to improve classification accuracy, it can be found that the improvement is not obvious for the beamsplitter error, but is more obvious for the phase shifter error. Compared with SEPN with 4 k parameters, SEPN with 10 k parameters improves the classification accuracy by an average of 0.7% and 7.17% under beamsplitter and phase shifter errors, respectively. In addition, the performance of the joint optimization mode and the separable optimization mode (indicated by “Sp” in the figure) of SEPN in DAT in MNIST classification are compared. Under the same scale of SEPN, the separable optimization mode is significantly better than the joint optimization mode, especially when the standard deviation gradually increases. In addition, no matter which training mode is selected, DAT with larger-scale SEPN has little improvement in accuracy under beamsplitter error, but relatively obvious improvement in performance under phase shifter error.

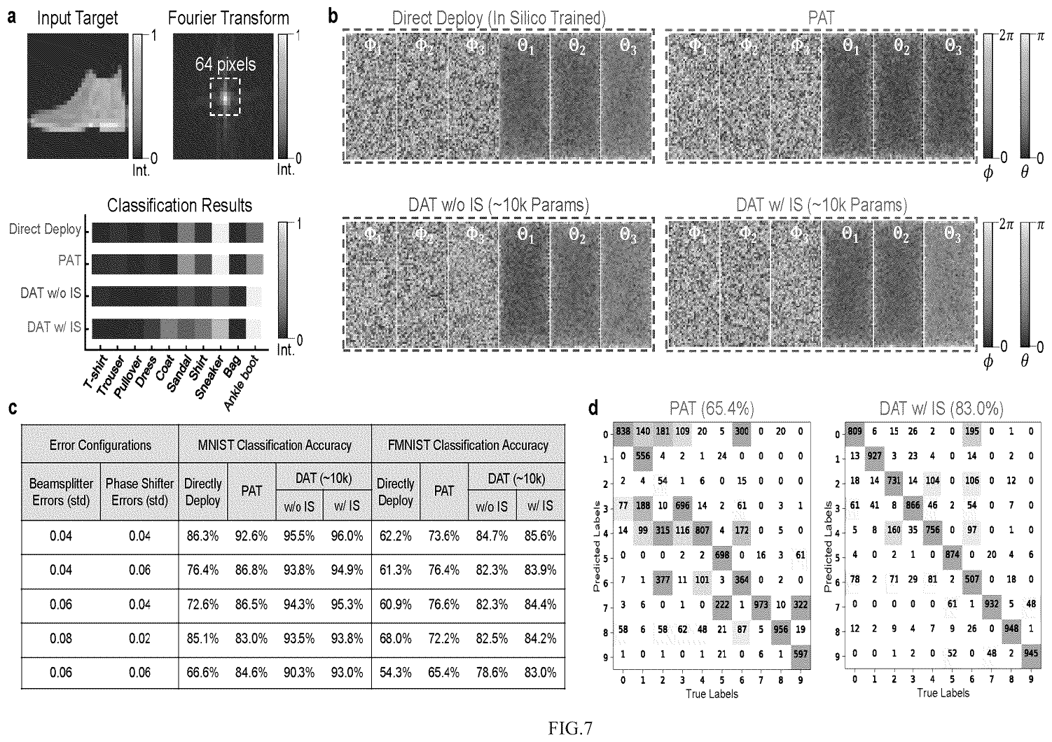

Referring to FIG. 7, which is schematic diagram of performance results of training MPNN under joint systematic errors according to an embodiment of the present application.

The classification table of MPNN under five joint systematic error configurations of different strengths shows the classification accuracy of DAT measuring and without measuring internal states. SEPN is updated in joint optimization mode and the parameter size is 10 k. It can be found that even without measuring the internal state, DAT is sufficient to adapt to moderate systematic errors. For example, when σ_{bs}=0.06 and σₚₛ=0.04, it can improve the MNIST/FMNIST classification accuracy from 72.6%/60.9% obtained by direct deployment to 94.3%/82.3%. For severe systematic errors, measuring the internal state can significantly improve classification accuracy. For example, when σ_{bs}=0.06 and σₚₛ=0.06, for the MNIST/FMNIST classification, the DAT measuring the internal state is 2.7%/4.4% higher than the DAT without measuring the internal state. Meanwhile, DAT outperforms PAT by a large margin, especially under severe errors. The results for FMNIST classification when σ_{bs}=0.06 and σₚₛ=0.06 are visualized. FIG. 7 depicts the intensities of input and output of the example product “ankle boot”. The input is the 64-pixel values in the center region of the Fourier-space representations, and the output is the intensities on ten photodetectors corresponding to ten categories. It demonstrates that in silico training and PAT fail to classify the example to the true category (the last detector), whereas DAT suppresses the errors and obtains the true classification result. FIG. 7 shows visualized results of the phase shifter. FIG. 7 further plots the confusion matrices representing the classification results of 10,000 products in the FMNIST test set, showing that DAT can effectively optimize the MPNN to extract the characteristics of some products that are hard to identify for PAT. For example, only 5.4% products of “pullover” (category no. 2) were correctly categorized for PAT, and the accuracy soared to 73.1% for DAT with measuring internal states.

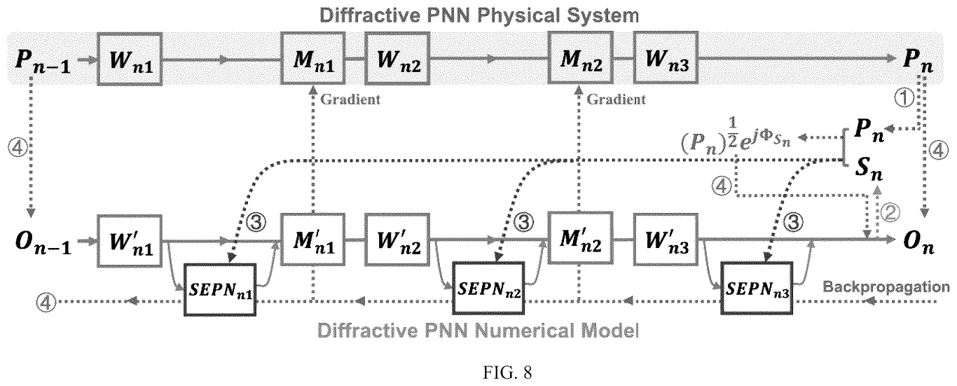

Referring to FIG. 8, which is a schematic diagram of the process of optimizing DPNN with DAT measuring internal states according to an embodiment of the present application. A cascaded DPNN-M is constructed, called DPNN-C, to demonstrate the principle of DAT. This principle can be easily extended to DPNN-S and DPNN-M. SEPNₙₖ for k=1, 2, 3 represents the SEPN attached to corresponding diffractive propagation layers, W′ₙᵢ, Wₙᵢ for i=1, 2, 3 represent the ideal and practical diffractive weight matrices, Oₙ and Pₙ represent the simulated and practical output intensity of the n-th block, M′ₙ₁, M′ₙ₂ and Mₙ₁, Mₙ₂ represent the ideal and practical phase modulation matrices, respectively. M′ₙₖ=diag(exp^{π}jΦₙₖ)) for k=1, 2 represents a matrix formed by the diagonalization of the vectorized phase modulation layer, and the phase modulation parameter is Φₙₖ, M′ₙₖ=diag(expπj(Φₙₖ+εₙₖ))), where j represents the imaginary unit and εₙₖ represents the phase shift error. Based on the Rayleigh-Sommerfeld diffraction principle, the forward propagation of the n-th block for DPNN-C physical system with N blocks can be formulated as follows:

$${U}_{n} = {W}_{n 3} {M}_{n 2} {W}_{n 2} {M}_{n 1} {W}_{n 1} {P}_{n - 1} ,$$

$${P}_{n} = {\vert {U}_{n} \vert}^{2} ,$$

the corresponding propagation processing of the numerical model with SEPNs can be formulated as:

$${U}_{n 1}^{′} = {M}_{n 1}^{′} [ {𝒩}_{n 1} ( {W}_{n 1}^{′} {O}_{n - 1} ) + {W}_{n 1}^{′} {O}_{n - 1} ] ,$$

$${U}_{n 2}^{′} = {M}_{n 2}^{′} [ {𝒩}_{n 2} ( {W}_{n 2}^{′} {U}_{n 1}^{′} ) + {W}_{n 2}^{′} {U}_{n 1}^{′} ] ,$$

$${S}_{n} = {𝒩}_{n 3} ( {W}_{n 3}^{′} {U}_{n 2}^{′} ) + {W}_{n 3}^{′} {U}_{n 3}^{′} ,$$

$${O}_{n} = {\vert {S}_{n} \vert}^{2} ,$$

where Uₙ, U′ₙ₁, U′ₙ₂ represent the vectorized complex optical fields; On represents the intensity of Sₙ; [symbol] ₙ₁, [symbol] ₙ₂, [symbol] ₙ₃ represent the functions expressed by the SEPNs; P₀=O₀=I represent the initial input.

Four steps of DAT are repeated over all training samples to minimize the loss functions until convergence for obtaining the numerical model and physical parameters. These steps are elaborated with one training sample as follows.

First, the optically encoded I is input to the physical system to perform the forward inference. In this processing, the internal states and final output values {Pₙ}ₙ₌₁^{N} are obtained.

Second, the same training sample I is digitally encoded and input into the numerical model to extract the internal states and the final output values {Sₙ}ₙ₌₁^{N}.

Third, parameters of the SEPNs are optimized by minimizing the similarity loss function in the unitary optimization mode or separable optimization mode. The similarity loss function is simplified to L_{S} (P, |S|²)=∥P_{N}−|S_{N}|²∥₂² without measuring internal states. The gradients of the similarity loss function with respect to A are calculated via the backpropagation to optimize the SEPNs, while the parameters of the physical model are fixed.

Fourth, state fusion is implemented to obtain new internal states and the final output values. For any n∈[1, N], Pₙ can contribute to the replacement of |Sₙ|² with Pₙ, and the fusion of Sₙ and Pₙ using the fusion function F_{N} (P_{N}, S_{N})=\sqrt{Pₙ}exp(jΦ_{S}_{ₙ}). The new internal states and observation are utilized to calculate the gradients to optimize the physical parameters of the PNN numerical model by minimizing the task loss.

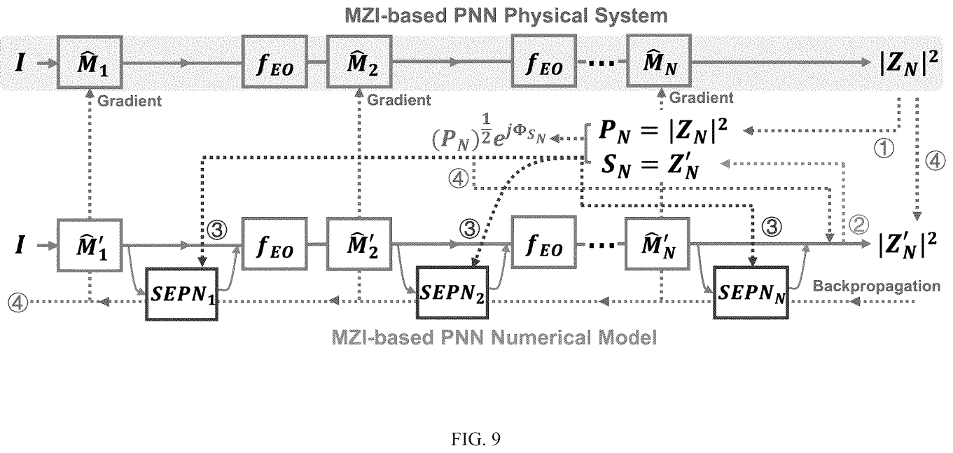

Referring to FIG. 9, which is a schematic diagram of the process of optimizing MPNN with DAT without measuring internal states according to an embodiment of the present application. I∈C^{L} represents the input complex optical filed, \hat{M}′ₙ and \hat{M}ₙ represent the ideal and practical transformation matrix of the n-th photonic mesh and Zn and Zₙ represent the simulated and practical output of the n-th photonic mesh, respectively. Mathematically, the forward propagation of the MPNN physical system can be described as:

$${Z}_{1} = {\hat{M}}_{1} I ,$$

$${Z}_{n} = {\hat{M}}_{n} {f}_{E O} ( {Z}_{n - 1} ) , 2 \leq n \leq N ,$$

The corresponding numerical model of the MPNN can be formulated as:

$${Z}_{1}^{′} = {𝒩}_{1} ( {\hat{M}}_{1}^{′} , I ) + {\hat{M}}_{1}^{′} I ,$$

$${Z}_{n}^{′} = {𝒩}_{n} ( {\hat{M}}_{n}^{′} {f}_{E O} ( {Z}_{n - 1}^{′} ) ) + {\hat{M}}_{n}^{′} {f}_{E O} ( {Z}_{n - 1}^{′} ) , 2 \leq n \leq N ,$$

where [symbol] ₙ represents the function expressed by SEPNₙ incorporated into the physical model with residual connections.

Four steps for DAT without internal states are repeated over all training samples to minimize the loss functions and optimize the physical model. The steps for one training sample are described in detail as follows.

First, I is optically encoded and inputted to the physical system through waveguide ports to implement a forward inference, with which the final output intensity P_{N}=|Z_{N}|² is measured.

Second, I is digitally encoded and input to the numerical model for the forward inference. To be consistent with P_{N}, the complex optical field S_{N}=Z′_{N} is only extracted.

Third, all the SEPNs are simultaneously optimized by minimizing the similarity loss function. As internal states are not measured, parameters of SEPNs are updated in the unitary optimization mode while the parameters of the physical model are fixed.

Fourth, P_{N} is fused with S_{N} to obtain \sqrt{P_{N}}exp(jΦ_{S}_{_{N}}) to replace S_{N}, and the simulated intensity |S_{N}|² of the numerical model is directly replaced by P_{N}. The new states and the replaced output are utilized to calculate the gradients of the task loss Lₜ with respect to the PNN physical model to update the parameters of the physical model. The parameters of the physical model are fixed.

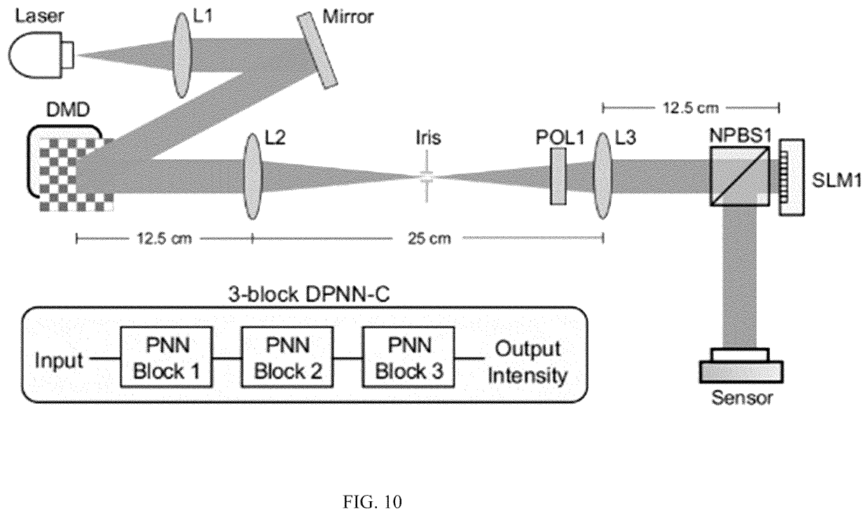

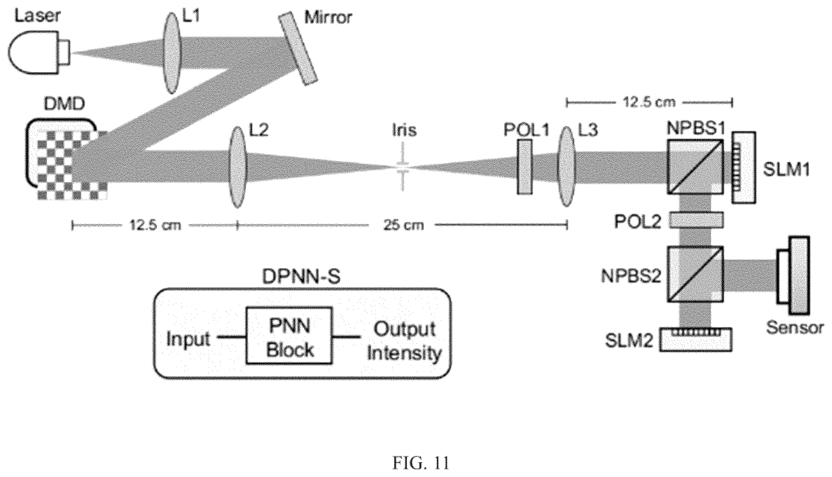

FIG. 10 is a first schematic structural diagram of a DPNN physical system for verifying a DAT method according to an embodiment of the present application. The DPNN physical system DPNN-C shown in FIG. 10 includes 3 PNN blocks with only one spatial light modulator (SLM). For DPNN-C, there is only one SLM in the PNN blocks, and the modulated optical field passes through a non-polarized beamsplitter (NPBS) with a split ratio of 50:50 (model; CCM1-BS015/M, Thorlabs), and diffraction propagates to a charge-coupled device (CCD) sensor. In DPNN-C, each PNN blocks only contains one spatial light modulator, which corresponds to two segments of free space light diffraction. The propagation distances for the first diffraction process (with the diffractive matrix Wₙ₁, n=1, 2, 3) is set to 0 and the second diffraction process (with the diffractive matrix Wₙ₂, n=1, 2, 3) is set to 15 cm. The mathematical forward model of the n-th (n=1, 2, 3) PNN block of the DPNN-C can therefore be defined as Pₙ=|Wₙ₂Mₙ₁Pₙ₋₁|².

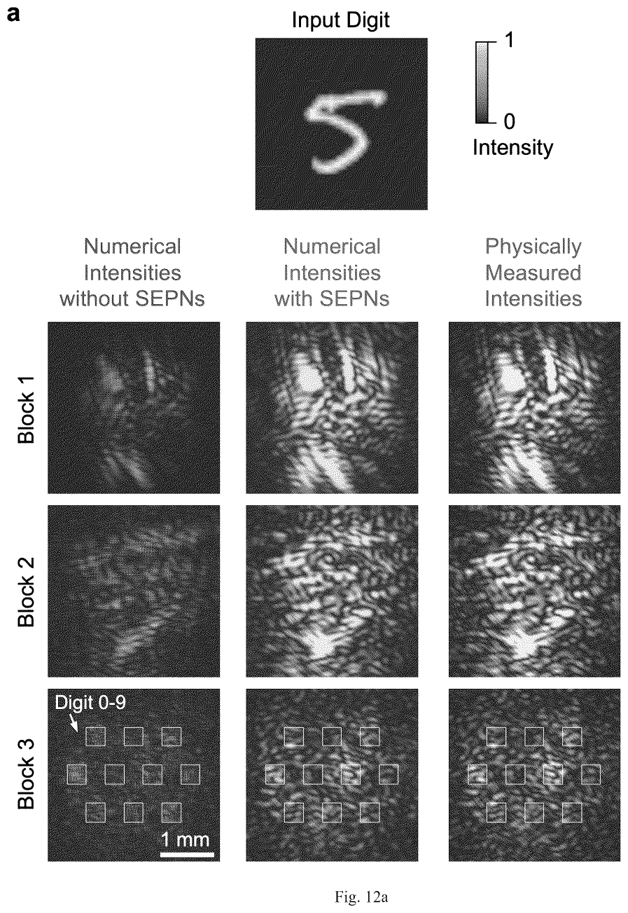

FIG. 11 is a first schematic structural diagram of a DPNN physical system for verifying a dual adaptive training method according to an embodiment of the present application. The DPNN physical system DPNN-S shown in FIG. 11 only includes 1 PNN block with two spatial light modulators (SLMs). For DPNN-S, there are two SLMs in the PNN blocks, the optical field from the first SLM is reflected by the first NPBS, passes through a linear polarizer, propagates to the second SLM, and then is reflected by the second NPBS to be propagated to the CCD sensor. The near-infrared indium gallium arsenide (InGaAs) CCD sensor plane contains 1,280×1,024 pixels, each pixel is 5×5 microns in size, has an accuracy of 10 bits, a response speed of 125 frames per second (f.p.s.), and is model Cobra2000-CL1280-130VT-00LUSTER. The PNN blocks of DPNN-S contains two spatial light modulators, which correspond to three segments of free space light diffraction. Like the DPNN-C, the first diffraction process is eliminated, and the distance between the two SLMs is set to 15 cm, and the distance between the second SLM and the CCD sensor is set to 10 cm. The mathematical forward model of the n-th PNN block of the DPNN-S can therefore be defined as P₁=|W₁₃M₁₂W₁₂M₁₁|². Following the numerical experiment settings, the number of input nodes of the digital micro-mirror device and the number of phase modulation pixels on the spatial light modulator are both set to 200×200 with a size of 17 μm.

The DPNN physical systems shown in FIG. 10 and FIG. 11 both use a digital micro-mirror device to encode the input information, and the CCD sensor to record the output optical field intensity. The PNN blocks of both DPNN physical systems are constructed from commercial optoelectronic equipment, and DPNN-C is implemented by repeatedly lighting the experimental platform of the same PNN blocks. The laser used in the experiment was generated by a solid-state fiber laser (FL-1550-SF, CNI) operating a wavelength of 1,550 nm. The coherent light wavefront is collimated using a relay lens (LB1106-C, Thorlabs), and then reflected onto a digital micromirror device (DMD) (DLP650LNIR, Texas Instruments) using a mirror (PF20-03-P₀₁, Thorlabs). The deflection angles of the microlenses (corresponding pixels) of the digital micro-mirror device are controlled by a control board (V650L, VIALUX) consisting of 1,280×800 micro-mirrors with a pitch of 10.8 μm and these mirrors can modulate the incident light at a maximum speed of 10,752 Hz. The optical field from the DMD, which is regarded as the input signal, is polarized using a linear polarizer (LPIREA100-C, Thorlabs) and then optically conjugated to the phase SLM (HSP1K-850-1650-PC8, Meadowlark) using a 4f system that comprises two relay lenses (LB1106-C, Thorlabs). An optical iris was placed at the Fourier plane of the 4f system to filter out high-order diffraction from the DMD. The phase SLM is a reflective liquid crystal on silicon that has a high zero-order diffraction efficiency of 95%. It consists of 1,024×1,024 modulation elements, each with a size of 17 μm and an 8-bit accuracy, and can operate at a maximum frame rate of 125 Hz with an update time of approximately 8 ms.

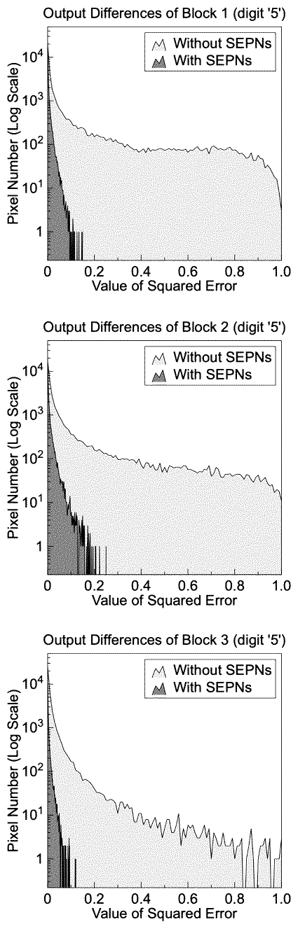

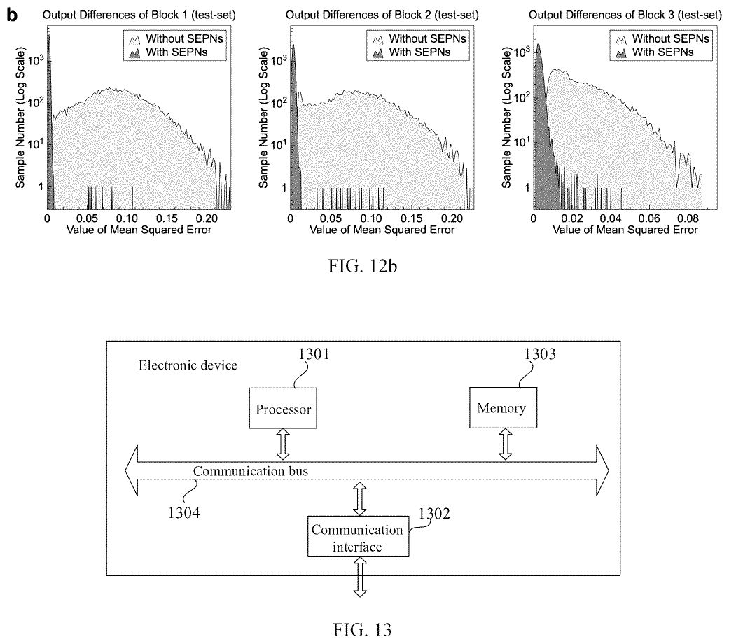

FIG. 12 is a schematic diagram showing experimental results of the DAT algorithm implemented on the DPNN physical system according to an embodiment of the present application. Training details are briefly described first. A digital computer (Windows, dubbed C1) was connected to the DMD, SLMs and CCD sensor, whereas another digital computer (Linux, dubbed C2) was used to construct the PNN numerical model and implement network training. The device control program and network training program are integrated into a unified code framework, and the response speeds of the devices are kept consistent using software synchronization. In each training iteration, C2 first transfers batched input images and phase modulation matrices to C1.C1 then assigns the data to DMD and SLMs, respectively, records the output intensities at the CCD sensor, and transfers them to C2. Finally, C2 utilizes the physically measured output intensities to optimize the SEPNs and physical system parameters. Due to the control delay of software, actual physical systems operate at 33 fps. The system operation frame rate can be greatly improved using wire triggers and customized controlling circuits.

Both the physical DPNN-S and DPNN-C were trained using the Adam optimizer, which was also used in the numerical experiments, and in silico training, adaptive training, and PAT and DAT processes are compared. Physical DPNN-C and DPNN-S were trained for 10 epochs using in silico training and PAT with a batch size of 32 and an initial learning rate of 0.01 decayed by 0.5 every epoch. When DPNN-C was trained, the training process consists of two stages: the first of which optimizes M₂₁ and M₃₁, and the second optimizes only M₃₁. Training was implemented 50 epochs for each stage with a batch size of 32 and an initial learning rate of 0.01 decayed by 0.5 every ten epochs. As for DAT, both DPNN-S and DPNN-C were trained with 5 epochs for MNIST and 8 epochs for FMNIST classification. The PNN physical model has an initial learning rate of 0.01 decayed by 0.5 every epoch. In addition, the cross-entropy loss function is utilized as the task loss for in silico training, PAT, and DAT, and the MSE loss function is employed as the task loss for adaptive training which is consistent with the original method settings. In physical experiments, the system working frame rate is 33 fps, the training time of one epoch using PAT and DAT is 1.1 and 2.8 h for DPNN-S, respectively, and 3.4 h and 7.2 h for DPNN-C, respectively.

The experimental results of DPNN-C are shown and analyzed below. When the quantization errors were present in the MNIST classification task modeled in a computer ideal model, the model accuracy reached 93.7% in an error-free environment; when this quantization error was not taken into account, the accuracy in the error-free environment soared to 98.0%. The FMNIST classification task encodes the input to pure phase, so there is no quantization error, and the model accuracy is 85.6% in an error-free environment. However, due to severe systematic errors, when the in silico trained model is directly deployed on the DPNN-C physical system, the MNIST and FMNIST classification accuracy were decreased to 28.3% and 11.1% respectively. On the MNIST classification task, PAT and adaptive training can only improve the accuracy to 39.6% and 53.1%, while the DAT method, which measures the intermediate state of the system, can significantly improve the accuracy to 92.4%.

FIG. 12 further compares the intermediate state and final output difference between the physical system and the numerical model under the same input, verifying the accuracy of the SEPN blocks. The left side of FIG. 12a visualizes the output results of the 1st, 2nd, and 3rd PNN blocks for the input digit “5” in the MNIST test set. The right side of FIG. 12a statistics the output difference between the numerical model and the physical system with and without the SEPN blocks at the pixel scale, and the indicator is the mean square error. It can be found that when the SEPN blocks is used in the numerical model, the output results of the numerical model are very similar to the physical system, but the difference is significant when the SEPN blocks is not used. The statistical histogram further supports this result. FIG. 12b evaluates the impact of using SEPN or without using SEPN on the entire MNIST test set on the output results at the image scale and the indicator is still the mean square error. It can be found that SEPN can accurately learn physical systematic errors and facilitate model training and task inference.

FIG. 13 is a schematic diagram of the physical structure of an electronic device. As shown in FIG. 13, the electronic device may include a processor 1301, a communication interface 1302, a memory 1303, and a communication bus 1304. The processor 1301, the communication interface 1302, and the memory 1003 communicate with each other through the communication bus 1304. The processor 1301 can invoke logical instructions in the memory 1303 to execute the dual adaptive training method of the photonic neural network, which will not be described again in the present application.

The electronic device may further include a data collection interface and a communication interface, where the data collection interface is used for data measurement and collection in the PNN physical system. The present application is not specifically limited here.

In addition, the logic instructions in the memory 1303 described above may be implemented in the form of a software functional unit and may be stored in a computer readable storage medium while being sold or used as a separate product. Based on such understanding, the technical solutions of the present application in essence or a part of the technical solutions that contributes to the prior art, or a part of the technical solutions, may be embodied in the form of a software product, which is stored in a storage medium, including several instructions to cause a computer device (which may be a personal computer, server, or network device, etc.) to perform all or part of the steps of the methods described in the respective embodiments of the present application. The storage medium described above includes various media that can store program codes such as U disk, mobile hard disk, read-only memory (ROM), random access memory (RAM), magnetic disk, or optical disk.

The present application further provides a non-transitory computer-readable storage medium having stored thereon a computer program that is executed by a processor to implement steps of the dual adaptive training method of the photonic neural networks. The method will not be described again in the present application.

Finally, it should be noted that the above embodiments are only used to explain the technical solutions of the present application, and are not limited thereto; although the present application has been described in detail with reference to the foregoing embodiments, it should be understood by those skilled in the art that they can still modify the technical solutions documented in the foregoing embodiments and make equivalent substitutions to a part of the technical features; these modifications and substitutions do not make the essence of the corresponding technical solutions depart from the scope of the technical solutions of various embodiments of the present application.

What is claimed is:

1. A dual adaptive training method of photonic neural networks (PNN), the dual adaptive training method comprising:
constructing, in a computer, a PNN numerical model comprising a PNN physical model and a systematic error prediction network model, wherein the PNN physical model is an error-free ideal PNN physical model of a PNN physical system, the systematic error prediction network model is an error model of the PNN physical system;
determining measurement values of the PNN physical system and measurement values of the PNN numerical model, wherein the measurement values of the PNN physical system comprise final output values of the PNN physical system, and the measurement values of the PNN numerical model comprise final output values of the PNN numerical model;
determining a similarity loss function based on comparison results between the measurement values of the PNN physical system and the measurement values of the PNN numerical model;
determining a task loss function based on fused results of the measurement values of the PNN physical system and the measurement values of the PNN numerical model; and
optimizing and updating parameters of the PNN numerical model based on the similarity loss function and the task loss function for in situ training of the PNN physical model, and a trained PNN is obtained.

2. The dual adaptive training method of claim 1, wherein the measurement values of the PNN physical system further comprise selectively measured internal states from the PNN physical system; and
the measurement values of the PNN numerical model further comprises selectively extracted internal states from the PNN numerical model.

3. The dual adaptive training method of claim 2, wherein determining the measurement values of the PNN physical system and the measurement values of the PNN numerical model comprises:
optically encoding each training sample to obtain input optical signals;
inputting the input optical signals into the PNN physical system, measuring the final output values of the PNN physical system and the internal states of the PNN physical system to obtain the measurement values of the PNN physical system;
digitally encoding each training sample to obtain input digital signals; and
inputting the input digital signals into the PNN numerical model, extracting the final output values of the PNN numerical model and the internal states of the PNN numerical model to obtain the measurement values of the PNN numerical model.

4. The dual adaptive training method of claim 1, wherein determining the similarity loss function based on comparison results between the measurement values of the PNN physical system and the measurement values of the PNN numerical model comprises:
determining, based on a comparison result between the internal states and the final output values of the PNN physical system and the internal states and final output values of the PNN numerical model, that the similarity loss function L_{S} in a unitary optimization mode is:
$${L}_{s} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2}$$
wherein P={Pₙ}ₙ₌₁^{N} are the measurement values of the PNN physical system, S={Sₙ}ₙ₌₁^{N} are the measurement values of the PNN numerical model in a unitary optimization mode, N is an integer greater than or equal to 1 and is the total number of internal states and final output values that can be obtained through measurement in the PNN physical system, n represents an integer between 1 and N (1<=n<=N), Pₙ represents the n-th measurable internal state or final output of the PNN physical system, Sₙ represents the internal states or final output values at a position corresponding to Pₙ in the PNN numerical model, Iₘₛₑ is the mean square error (MSE) function, and αₙ is a coefficient to weight the n-th MSE function.

5. The dual adaptive training method of claim 4, wherein determining the task loss function based on the fused results of the measurement values of the PNN physical system and the measurement values of the PNN numerical model comprises:
determining, based on fused results of the final output values of the PNN physical system and final output values of the PNN numerical model, that the task loss function Lₜ is:
$${L}_{t} ( {\vert {F}_{N} ( {P}_{N} , {S}_{N} ) \vert}^{2} , T ) ;$$
wherein T represents a task target; Lₜ is the task loss function; F_{N} (P_{N}, S_{N}) represents the fused results.

6. The dual adaptive training method of claim 5, wherein optimizing and updating parameters of the PNN numerical model based on the similarity loss function and the task loss function for in situ training of the PNN physical model comprises:
minimizing the similarity loss function L_{S} in a unitary optimization mode to update parameters of the systematic error prediction network model;
$${min}_{Λ} \{ {L}_{S} ( P , {\vert S \vert}^{2} ) = {\sum }_{n = 1}^{N} {α}_{n} {l}_{m s e} ( {P}_{n} , {\vert {S}_{n} \vert}^{2} ) = {\sum }_{n = 1}^{N} {α}_{n} {‖ {P}_{n} - {\vert {S}_{n} \vert}^{2} ‖}_{2}^{2} \}$$
wherein Λ are learnable parameters of the systematic error prediction network model;
minimizing the task loss function Lₜ to update the parameters of the PNN physical model;
$${min}_{Ω} \{ {L}_{t} ( {\vert {F}_{N} ( {P}_{N} , {S}_{N} ) \vert}^{2} , T ) \} ;$$
$${\{ {F}_{N} ( {P}_{N} , {S}_{N} ) = \sqrt{{P}_{n}} exp ( j {Φ}_{{S}_{n}} ) \}}_{n = 1}^{N} ;$$
wherein Ω are learnable parameters of the PNN physical model; j is an imaginary unit, Φ_{S}_{ₙ} is the phase of the complex optical field signal; when the PNN physical model does not converge, steps of minimizing the similarity loss function L_{S} in the unitary optimization mode to update the parameters of the systematic error prediction network model and minimizing the task loss function Lₜ to optimize and update the parameters of the PNN numerical model are performed to update the parameters of the PNN physical model for in situ training of the PNN physics model.

7. The dual adaptive training method of claim 2, wherein determining the similarity loss function based on comparison results between the measurement values of the PNN physical system and the measurement values of the PNN numerical model comprises:
determining, based on comparison results between the final output values and internal states of the PNN physical system and the final output values and internal states of the PNN numerical model that the similarity loss function in a separable optimization mode is:
$${L}_{s , n} ( {P}_{n} , {\vert {\overline{S}}_{n} \vert}^{2} ) = {l}_{m s e} ( {P}_{n} , {\vert {\overline{S}}_{n} \vert}^{2} ) = {‖ {P}_{n} - {\vert {\overline{S}}_{n} \vert}^{2} ‖}_{2}^{2}$$
wherein N is an integer greater than or equal to 1, n represents an integer between 1 and N (1<=n<=N), and Pₙ represents the n-th measurable internal states or final output values of the PNN physical system, S̅ₙ represents the internal states or final output values at a position corresponding to Pₙ of the PNN numerical model in the separable optimization mode.

8. The dual adaptive training method of claim 1, wherein the PNN physical system is a diffractive photonic neural network (DPNN) physical system, and the DPNN physical system is a DPNN physical system with a single block or a DPNN physical system with multiple blocks.

9. The dual adaptive training method of claim 3, wherein the systematic error prediction network model is incorporated into the PNN physical model with residual connections.

10. The dual adaptive training method of claim 3, wherein the measurement values of the PNN physical system are optical field intensities, and the final output values of the PNN numerical model are complex optical fields with amplitudes and phases.

11. An electronic device, comprising
a processor; and
a memory storing a computer program and, the computer program, when executed by the processor, causes the processor to implement steps of the dual adaptive training method of the photonic neural networks of claim 1.

12. A non-transitory computer-readable storage medium having stored thereon a computer program that is executed by a processor to implement steps of the dual adaptive training method of the photonic neural networks of claim 1.

13. A diffractive photonic neural network (DPNN) physical system for verifying the dual adaptive training method of the photonic neural networks of claim 1, the DPNN comprising:
a photonic neural network (PNN) block comprising a first spatial light modulator (SLM) and a second SLM;
an optical field from the first SLM is reflected by a first non-polarized beamsplitter (NPBS), passes through a linear polarizer, propagates to the second SLM, and then is reflected by a second NPBS to be propagated to a charge-coupled device (CCD) sensor; and
a distance between the first SLM and the second SLM is set to a first value, and a distance between the second SLM and the CCD sensor is set to a second value.

14. A diffractive photonic neural network (DPNN) physical system for verifying the dual adaptive training method of the photonic neural networks (PNN) of claim 1, the DPNN comprising:
three PNN blocks each of which comprises one spatial light modulator (SLM); and
an optical field modulated by the SLM in each PNN block passes through a non-polarized beamsplitter to be propagated to a charge-coupled device (CCD) sensor.
